(19) United States
(12) Patent Application Publication
(10) Pub. No.: US 2025/0173632 A1
(43) Pub. Date: May 29, 2025

(54) Methods and Systems for Alternative Electronic Itinerary Generation Using Interactive Generative Artificial Intelligence

(71) Applicant: UNITED AIRLINES, INC., Chicago, IL (US)

(72) Inventors: Julee Evans, Katy, TX (US); Imran Ullah Mohammad, Cypress, TX (US); Robert Bence, Prosper, TX (US)

(21) Appl. No.: 18/957,599

(22) Filed: Nov. 22, 2024

Related U.S. Application Data
(60) Provisional application No. 63/602,517, filed on Nov. 24, 2023.

(51) Int. Cl. G06Q 10/02

(52) U.S. Cl. CPC G06Q 10/025

(57) ABSTRACT

Response to interruption of a travel itinerary of a traveler, systems and methods configure an interactive generative artificial intelligence system to provide an electronic chat interface for a traveler and provide prompt responses to the traveler including information on the interruption and optionally an automatically rebooked itinerary. Additionally, the interactive generative artificial intelligence system receives prompts based on prompt inputs from the traveler and accesses routing data corresponding to one or more alternative travel itineraries. The routing data may include different travel locations and different travel modes determined based on the prompt inputs provided by the traveler to the interactive generative artificial intelligence system. Prompt responses containing information on alternative travel itineraries generated via interactive generative artificial intelligence system are displayed to the traveler.

### CROSS-REFERENCE TO RELATED APPLICATIONS

This application claims priority to U.S. Provisional Application No. 63/602,517, filed Nov. 24, 2023, which is incorporated herein by reference in its entirety.

### BACKGROUND

Weather related travel interruptions create many challenges. For travelers, the challenges are well known. Travel interruptions can result in lengthy delays, missed connections, missed time at vacation destinations, and the like. In some cases, travelers must look to change all or parts of their travel plans, for example, by rerouting through other destinations or canceling all or parts of a travel itinerary entirely. For carriers, weather related travel interruptions can offer considerable technical challenges. Weather interruptions do not impact only a few travelers, but rather many. Carriers must make available agents at impacted airports and via remote access. Carriers must commit sufficient computing resources for those personnel to engage with travelers helping them seek alternative bookings, itinerary rerouting, and cancelation vouchers.

Carriers refer to the overall operations around weather related travel interruptions as IRROP (“irregular operations weather system outage”). Conventional IRROP operations only re-route travelers to the same location in the original booked itinerary. Individual agents may be empowered to re-route travelers to different locations, but there are various limitations and guardrails that can limit their ability in that regard. Data shows that when presented with alternate options for re-routed travel, approximately 6-8% of travelers choose the option of being re-routed to an alternate city. And, it is believed that those re-routes often occur for close proximity locations, for example, a traveler accepting to be re-routed to Baltimore for an original booking to Washington DC, or being re-routed to New Jersey for an original booking to New York City.

None of the conventional techniques for addressing weather related and other travel interruptions provide personalized rebooking options, especially none that allow for rebooking with entirely different routing options, from different destinations to different modes of transportation.

### SUMMARY OF THE INVENTION

The present application describes computing systems and techniques for generating alternative routing of an electronic travel itinerary, for example, in response to travel interruption event. More particularly, alternative routing is generated using an interactive generative artificial intelligence system that interfaces with affected travelers, geolocation computing systems, and computing systems identifying electronic alternative routing options to provide textual and visual indications of available alternative travel options for an affected electronic travel itinerary. In various examples, the interactive generative artificial intelligence system may coordinate automatic rebooking of the affected electronic travel itinerary, booking of alternative travel modalities in response, or handoffs to external systems for booking alternative travel arrangements. In various examples, the prompt response responses/chatbot outputs generated by the interactive generative artificial intelligence system are generated from trained machine learning models of the system.

The interactive generative artificial intelligence system of the present application may deploy trained machine learning models trained on and responsive to data such as traveler identification data, traveler demographic data, travel itinerary data including historical itinerary data, prior traveler chat response data, traveler preference data, traveler classification/traveler status, and other similar data. Such travel data may be specific to the particular traveler or global traveler data collected from a large database of travelers. Additional data that these machine learning models may be trained on and respond to include electronic map data, carrier travel data including capacity and availability data, carrier travel interruption rules, third-party traveler incentives data, alternative carrier travel capacity and availability data, alternative travel modality data such as ride sharing data, car rental data, hotel data, alternative aircraft data.

According to an aspect of the present disclosure, a computer-implemented method for generating alternative routing of a travel itinerary using an interactive generative artificial intelligence system, the method includes: in response to receiving an electronic indication of an interruption of a travel itinerary of a traveler, obtaining travel identification data for the traveler and itinerary data corresponding to the traveler; configuring an interactive generative artificial intelligence system for providing respective interaction chat interfaces electronically to the traveler, the interactive generative artificial intelligence system comprising a plurality of trained system objects, each system object including a respective trained machine learning module; in response to an access request from the traveler, causing the interactive generative artificial intelligence system to provide interaction interfaces (that include may include prompt responses) to the user regarding the interruption of the travel itinerary and to receive prompt inputs from the traveler responsive to the interaction interface; in response to the prompt inputs from the traveler, accessing routing data corresponding to one or more alternative travel itineraries; and causing, through the interaction interface provided by the interactive generative artificial intelligence system, information on the one or more alternative travel itineraries to be displayed to the traveler as prompt responses, including generating and displaying a visual indication of the information on the one or more alternative travel itineraries.

In a variation of this aspect, accessing the routing data corresponding to one or more alternative travel itineraries includes: generating, from data of the itinerary data and from the prompt inputs from the traveler provided to the interactive generative artificial intelligence system, polling data; and accessing, with the polling data, a booking computing system selected from the group consisting of a carrier computing system, a hotel computing system, a car rental computing system, a ride sharing computing system, and an online travel agency computing system.

In another variation of this aspect, the method further includes responsive to the polling data, generating, at the booking computer system, the information on the one or more alternative travel itineraries.

In another variation of this aspect, the method further includes responsive to the polling data, generating, at the booking computer system, available travel data; receiving the available travel data from the booking computer system; and responsive to the available travel data, generating the information on the one or more alternative travel itineraries.

In another variation of this aspect, the method further includes generating, from data of the itinerary data and from the prompt inputs from the traveler provided to the interactive generative artificial intelligence system, polling data; and communicating the polling data to an online travel agency computing system to cause the online travel agency computing system (i) to generate the information on the one or more alternative travel itineraries and (ii) to communicate the information on the one or more alternative travel itineraries to the interactive generative artificial intelligence system.

In another variation of this aspect, the itinerary data comprises an original travel destination and an original travel modality, wherein the one or more alternative travel itineraries include at least one alternative travel itinerary having a travel destination different than the original travel destination.

In another variation of this aspect, the itinerary data comprises an original travel destination and an original travel modality, wherein the one or more alternative travel itineraries include at least one alternative travel itinerary having a travel modality different than the original travel modality.

In another variation of this aspect, there are plurality of the alternative travel itineraries and the method further includes: responsive to the prompt inputs from the traveler, ranking the plurality of alternative travel itineraries; and displaying at least a portion of the ranking of the plurality of alternative travel itineraries through the interaction interface provided by the interactive generative artificial intelligence system, wherein the visual indication corresponds to the ranking of the plurality of alternative travel itineraries.

In another variation of this aspect, there are a plurality of the alternative travel itineraries and the method further includes: obtaining map data, alternative route data, and booking data and providing the map data, the alternative route data, and the booking data to a trained graph-network machine learning model trained to generate a graph network of available route alternatives, the graph network comprising a plurality of nodes, each node representing a different alternative travel destination different than an original travel destination of the itinerary.

In another variation of this aspect, the method further includes assessing, in a trained machine learning model, the graph network against the prompt inputs from the traveler and applying weights to each of the plurality of nodes based on the prompt inputs from the traveler.

In another variation of this aspect, the method further includes applying updated weights to each of the plurality of nodes in response to subsequent prompt inputs from the traveler to the interactive generative artificial intelligence system.

In another variation of this aspect, the method further includes applying weights to each of the plurality of nodes based historical data corresponding to the traveler.

In another variation of this aspect, the historical data comprises previously provided prompt inputs from the traveler to the interactive generative artificial intelligence system from a previous alternative routing session.

In another variation of this aspect, the method further includes updating the graph network with real-time travel availability data from a carrier and/or real-time booking data from a booking computer system.

In another variation of this aspect, the visual indication of the information on the one or more alternative travel itineraries comprises map data corresponding to an original travel destination for the itinerary data and map data corresponding to an alternative travel destination different than the original travel destination.

In another variation of this aspect, the method further includes in response to prompt input from the traveler having received the information on the one or more alternative travel itineraries, generating an alternative travel itinerary corresponding to a selected alternative travel itinerary.

In another variation of this aspect, the method further includes generating a booking request corresponding to the selected alternative travel itinerary; communicating the booking request to an external booking system requesting a booking and a booking confirmation; and in response to receiving the booking confirmation, confirming the alternative travel itinerary to the traveler.

In another variation of this aspect, the method further includes identifying a plurality of interruptions of travel itineraries each corresponding to different secondary travelers, obtain travel identification data for the secondary travelers and itinerary data corresponding to the secondary travelers; and determining the one or more alternative travel itineraries based on (i) the plurality of interruptions of travel itineraries, (ii) the travel identification data for the secondary travelers, and/or (iii) the itinerary data corresponding to the secondary travelers.

In another variation of this aspect, the information on the one or more alternative travel itineraries includes information obtained from an airline reservation database.

In another variation of this aspect, the information obtained from the airline reservation database comprises flight information for flight segments of the one or more alternative travel itineraries.

According to another aspect of the present disclosure, a computing system for generating alternative routing of an travel itinerary using an interactive generative artificial intelligence system, the computing system includes: one or more processors, and one or more memories having stored thereon computer-executable instructions that, when executed by the one or more processors, cause the computing system to: in response to receiving an electronic indication of an interruption of a travel itinerary of a traveler, obtain travel identification data for the traveler and itinerary data corresponding to the traveler; configure an interactive generative artificial intelligence system for providing respective interaction interface electronically to the traveler, the interactive generative artificial intelligence system comprises a plurality of trained system objects, each system object including a respective trained machine learning module; response to an access request from the traveler, cause the interactive generative artificial intelligence system to provide interaction interfaces (that include may include prompt responses) to the user regarding the interruption of the travel itinerary and to receive prompt inputs from the traveler responsive to the interaction interfaces; in response to the prompt inputs from the traveler, access routing data corresponding to one or more alternative travel itineraries; and cause, through the interaction interface provided by the interactive generative artificial intelligence system, information on the one or more alternative travel itineraries to be displayed to the traveler as prompt responses, including to generate and to display a visual indication of the information on the one or more alternative travel itineraries.

### BRIEF DESCRIPTION OF THE DRAWINGS

The figures described below depict various implementations of the system and methods disclosed therein. It should be understood that each figure depicts one implementation of a particular implementation of the disclosed system and methods, and that each of the figures is intended to accord with a possible implementation thereof. Further, wherever possible, the following description refers to the reference numerals included in the following figures, in which features depicted in multiple figures are designated with consistent reference numerals.

The figures depict preferred implementations for purposes of illustration only. One skilled in the art will readily recognize from the following discussion that alternative implementations of the systems and methods illustrated herein may be employed without departing from the principles of the invention described herein, in accordance with an example.

FIG. 1 illustrates an example of a travel booking system, including an interactive generative artificial intelligence system for implementing the processes and methods described herein.

FIG. 2A illustrates a partial architecture of an alternative routing controller as by used in the travel booking system of FIG. 1, in accordance with an example. FIG. 2B illustrates a process using a generative artificial intelligence system to generate alternative travel itineraries using the alternative routing controller for FIG. 2A, in accordance with an example.

FIG. 3 illustrates another example travel booking system, showing a detailed user computing device and interactive general artificial intelligence system accessing numerous booking systems, in accordance with an example.

FIG. 4 illustrates an example implementation of a large language model/chatbot implemented in the interactive general artificial intelligence system of FIG. 3, in accordance with an example.

FIGS. 5A-5D illustrate different example screens that may be presented to a user at a user mobile device, in accordance with an example.

FIG. 6 illustrates another example process using a generative artificial intelligence system to generate alternative routing itineraries, in accordance with an example.

FIG. 7 illustrates tables of ranked alternative itineraries (at least some of which have alternative routing compared to an interrupted itinerary) generated by the process of FIG. 6, in accordance with an example.

FIG. 8 illustrates a display of some of the ranked alternative itineraries as presented to a user on a user mobile device.

### DESCRIPTION

The present disclosure describes systems and methods that overcome limitations of conventional travel itinerary rebooking systems, such as conventional irregular operations weather system outage (“IRROP”) systems and protocols. Systems and methods integrate generative artificial intelligence (Gen AI) platforms with travel booking systems to provide automated rebooking features for customers through leveraging conversational contextual personalized messaging and chat operations with real time travel data on alternative travel options for identifying suitable alternative travel options for customers. Through integration of Gen AI with travel booking systems, personalized automatically generated alternative travel options are now a reality for customers. Integration with Gen AI allows booking systems to obtain and consider a larger nexus of data and options when performing the ordinarily complex computational tasks of booking and rebooking. Expanded data on travel times and arrivals times (total travel time) can now be better leveraged through inclusion of expanded data on options for different modes of travel, as well as data on distances affecting the different travel options, to provide users with better and more expansive rebooking options.

In various aspects of the present disclosure, systems and methods described include a computer-implemented method for generating alternative routing of a travel itinerary using an interactive generative artificial intelligence system. The techniques herein may include, in response to receiving an electronic indication of an interruption of a travel itinerary of a traveler, obtaining travel identification data for the traveler and itinerary data corresponding to the traveler. Further, the techniques include configuring an interactive generative artificial intelligence system for providing respective interaction interfaces (including prompt responses/chatbot outputs) electronically to the traveler, the interactive generative artificial intelligence system comprising a plurality of trained system objects, each system object including a respective trained machine learning module. In response to an access request from the traveler, the techniques may cause the interactive generative artificial intelligence system to provide interaction interfaces to the user regarding the interruption of the travel itinerary and to receive prompt inputs from the traveler responsive to the interaction interfaces. In response to the prompt inputs from the traveler, the systems and methods may access routing data corresponding to one or more alternative travel itineraries. Further, the techniques may cause, through the interaction interfaces provided by the interactive generative artificial intelligence system, information on the one or more alternative travel itineraries to be displayed to the traveler, including generating and displaying a visual indication of the information on the one or more alternative travel itineraries.

### Example Booking System

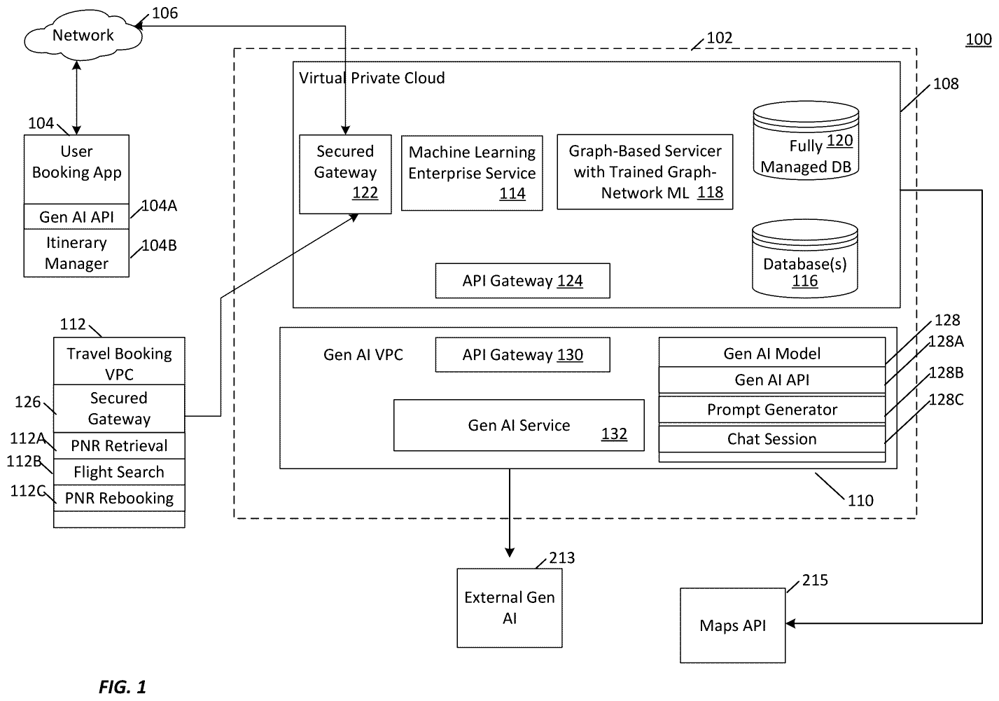

FIG. 1 illustrates an example of a travel booking system 100 in accordance with an example and including an interactive generative artificial intelligence (Gen AI) system, for implementing various processes and methods described herein. In the illustrated example, the travel booking system 100 includes a cloud server 102 communicatively coupled (through a network 106) to a user booking application (APP) 104, for example, stored and executing in a user computing device or other computing system. The cloud server 102 includes three main components, in the illustrated example: an interface virtual private cloud (VPC) 108; a Gen AI VPC 110; and a travel booking VPC 112. While shown in a particular architecture, it will be appreciated that any number of cloud server architectures may be used to implement the techniques herein.

As illustrated, the VPC 108, as a primary VPC, is configured to coordinate access and data transfer between the user booking APP 104, the Gen AI VPC 110, and the travel booking VPC 112. That coordination includes conventional processes of travel booking for a user, but additionally includes generative AI-informed generation of alternative routing of travel itineraries in response to interruptions to a user's current travel itineraries. In the illustrated example, a machine learning (ML) enterprise service 114 provides indexing functionality for searching structured and unstructured data from various sources, including documents, electronic data, imaging data, and databases 116, for example databases of user data (e.g., passenger data), travel itinerary data, seat inventory, flight schedules, etc. The ML enterprise service 114 can integrate data from various storage services and can, in various examples, offer natural language processing (NLP) functionality to provide accurate search results in response to natural language queries, or example provided through a Gen AI created chat session, i.e., an interface for entering prompt inputs.

In the illustrated example, the databases 116 may be implemented as a scalable object storage service that stores and retrieve large amounts of data, including up to date travel itinerary data, up to data flight (and other equipment) status data, historical data, image data, mapping data, etc. for affecting the methods and processes herein. In various examples, implementations as a scalable object storage service support durable storage with customizable access controls, offering bucket policies and encryption for data security, providing a versatile storage backend for the travel booking system 100. Further, access to the databases 116 may be restricted to specific VPCs, such as VPC 110 and VPC 112, using VPC endpoints. By configuring an endpoint, applications in the VPC can securely interact with the database 116 without exposure through a public network which network 106 interfacing with the user booking APP 104 may represent.

Further, the VPC 108 includes a database servicer 118 for managing the stored and querying of data by the VPC 108. In the illustrated example, the database servicer 118 may be a graph-based servicer capable of supporting both property graphs and RDF (Resource Description Framework) for semantic queries. In particular, in various examples of the present techniques, the generation of alternative travel itineraries includes using a graph-based analysis through a trained graph-network machine learning model implemented at the graph-based servicer 118 combined with function calling to generative artificial intelligence services herein, such as the Gen AI and LLM/chatbot services described. For example, as discussed in various examples herein, the graph-based servicer 118 may be configured with one or more graph-network ML model trained to, in response to receiving real-time map data, alternative route data, and travel itinerary data, generate a graph network of available travel (including route) alternatives, where that graph network contains nodes, each node representing a different alternative travel destination different than an original travel destination of the itinerary, with relationships between different nodes provided as edges in the graph network. The graph-based servicer 118 may be configured to update the graph network with real-time travel availability data from a carrier and/or real-time booking data from a travel booking computer system, where that booking system may be the system 100 or an external travel booking system. The graph-based servicer 118 allows for not only managing the number of nodes and the relationships between nodes, but also allows for performing complex queries on the storage graph network.

The graph-based servicer 118 may generate a graph network of alternative travel itineraries, having nodes and edge connections between nodes. In some examples, the graph-based servicer 118 may include a trained machine learning model or other process that interfaces a generative artificial intelligence service to obtain data generated from natural language prompt inputs from a traveler. The graph-based servicer 118 determines, from that generated data, weights to be applied to the nodes and/or edges of the graph network to incorporate a traveler's preferences when generating alternative travel itineraries and when ranking the same. The integration of a graph-based servicer with a generative artificial intelligence service, such as the Gen AI VPC 110, allows for updating those node weights and edge weights in response to subsequent prompt inputs from the traveler to that interactive generative artificial intelligence system. Further, as discussed, in various examples, traveler profile data and historical data on past travel itineraries of the traveler may be used by a graph-based servicer to determine node weights and edge weights for generating and ranking itineraries. The graph-based servicer may access such data, in particular data from past alternative routing of interrupted travel, and determine appropriate weights that correspond to a traveler's past preferences for alternative destinations, acceptable distances from an original destination, acceptable modes of transportation, importance of minimizing travel time, importance of minimizing number of layover stops, importance of minimizing number of different travel modalities to be used in generating alternative travel itineraries, etc. In some examples, the historical data includes previously provided prompt inputs from the traveler to the interactive generative artificial intelligence system from a previous alternative routing session.

To effectuate database queries, the VPC 108 further includes a fully managed database 120 (e.g., a NoSQL database) designed for high performance and scalability, offering key-value and document storage. The fully managed database 120 may be optimized for applications that require fast (e.g., millisecond or faster) response times, including the user booking APP 104 during a chat session between a user device and the VPC 110. For example, the fully managed database 120 may support high-throughput workloads, allowing the VPC 108 to manage data through fast, scalable API's for web applications, such as the user booking APP 104 and/or components thereof.

In the illustrated example, secured communications with the VPC 108 are achieved through a security gateway 122 connecting to the user booking APP 104 or through an API gateway 124 connecting to the travel booking VPC 112 and the Gen AI VPC 110. Although, in other examples, either or both of the VPCs 110/112 may contain APIs configured to communicate with the VPC 108.

In the illustrated example, the travel booking VPC 112 may be stored on a separate computing device or separate cloud server and includes a secured gateway 126 providing secured communications with the VPC 108. The VPC 112, more generally, may represent any travel booking system providing booking/rebooking operations. The travel booking VPC 112 further includes a Passenger Name Record (PNR) retrieval application 112A configured to retrieve, confirm, and/or update PNR data in response to calls from the VPC 108 and/or from the user booking APP 104. The PNR may be a digital record of a passenger's travel information, including their itinerary, contact information, and payment details, for examples. For example, the PNR data may be created when a traveler makes a reservation and is used by carriers, travel agencies, and global distribution systems (GDS) to manage reservations. In various examples, the PNR data represents real-time booking data for a user stored at the VPC 112, where some or all of that data is also stored at a user's computing device, such as a user's mobile device.

The travel booking VPC 112 further includes a flight search application 112B that retrieves, confirms, and/or updates real-time travel availability information for travel services corresponding to a traveler's PNR as well as, in some examples, alternative available travel services. For example, the application 112B may access flight status data on current flights corresponding to a PNR, as well as, in response to requests, alternative flights available either through the same carrier or different carriers. That is, the travel booking VPC 112 may provide available travel data on available alternative routes, including alternative modes of travel, in response to requests. In various examples, discussed further, the search application 112B may be implemented to search for alternative travel services of an entirely different modality than the travel services on the PNR. As used herein “modality” refers to a mode of transportation, such as via aircraft, ground based vehicle, walking, or rail. In some examples, modalities may differ within such groups, for example, a commercial jet engine aircraft may be considered a different travel modality than a helicopter or personalized aircraft, each differing my relying upon a differentiated design principle or principles. A PNR rebooking application 112C manages rebooking of the travel itinerary in a PNR, in accordance with various examples herein. The flight search application 112B may be part of an airline reservation system or may access such a system or other airline reservation database containing flight information on a current travel itinerary and alternative travel options.

The VPC 110 provides an interactive Gen AI system configured to manage the provision of respective interaction interfaces (including prompt responses/chatbot outputs) electronically to a traveler, through the user booking APP 104 or other service. The VPC 110 may coordinate with the VPC 108 having one or more trained objects, each including a respective trained machine learning module, for managing functions for identifying, displaying, and booking alternative routing of interrupted travel itineraries. In response to access requests from a user through the user booking APP 104, for example, the VPC 110 may provide interaction interfaces to the user regarding an interruption of the travel itinerary, and the VPC 110 may receive prompt inputs from the traveler responsive to the interaction interfaces, where those prompt inputs cause the VPC 110, the VPC 108, and/or the VPC 112 to access routing data corresponding to one or more alternative travel itineraries, for example. These prompt inputs may be received and serve as the prompts to the Gen AI/LLM/Chatbot services, herein, for example. In the illustrated example, the Gen AI VPC 110 includes a Gen AI modeler 128 having a Gen AI API 128A for interfacing with an API gateway 130 for communicating with the VPC 108, the VPC 112, and the user booking APP 104. A prompt request generator 128B is used to instruct the user booking APP 104 to open and display an interface to a user on user computing device, from which a chat session 128C may be opened for receiving prompt inputs from the user accessing that session. The prompt request generator 128B, in some examples, may adjust interfaces with updated natural language responses (e.g. prompt responses, chatbot outputs, or other information) and/or updated natural language queries that are to be displayed on the user booking APP 104. For example, such natural language responses displayed to the user may result from information generated on alternative itineraries, information determined by the Gen AI/LLM/Chatbot service to be useful context for the user to elicit subsequent prompt inputs.

In various examples, a Gen AI service 132 controls operation of the Gen AI VPC 110, including training and updating the Gen AI model 128. For example, the Gen AI service 132 may include a module for building and/or updating the Gen AI model 128, along with providing a pipeline to the model 128 for data preprocessing, model deployment, and model monitoring. The Gen AI service 132 may be configured to access data and services within the VPC 110, the VPC 108, and/or the VPC 112, through VPC endpoints, private subnets, etc. The Gen AI service 132 may further provide compute services that run support various triggers, including HTTP requests, database changes, and message queue events. Further, the Gen AI service 132 may access resources like databases or storage services securely. The Gen AI service 132 further allows the Gen AI model 128 to access external Gen AI services or other large language models or chatbots, to leverage potentially larger language models or more recently updated large language models for text generation, summarization, etc. for use during the chat session 128C. The Gen AI service 132 may provide and maintain a secure, private connection to such external Gen AI systems.

The user booking APP 104 may include numerous features associated with searching for available travel resources and itinerary options, booking travel itineraries, generating PNR data, and other conventional travel related resources available to users through mobile devices and/or web accessible services, for example available through an itinerary manager 104B. Additionally, in accordance with various examples of the present techniques, the user booking APP 104 includes Gen AI APP 104A for interfacing with the Gen AI VPC 110 to implement the methods and processes herein.

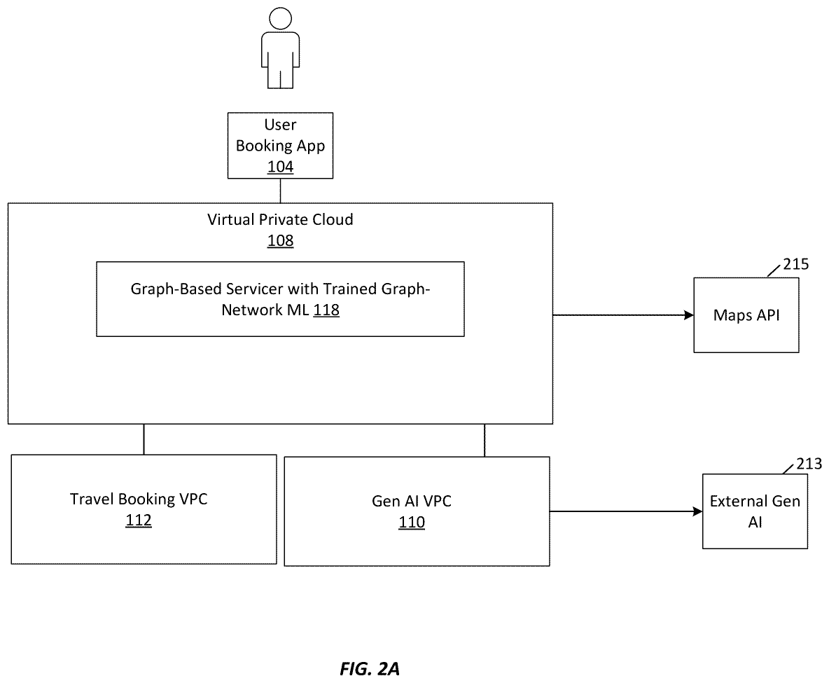

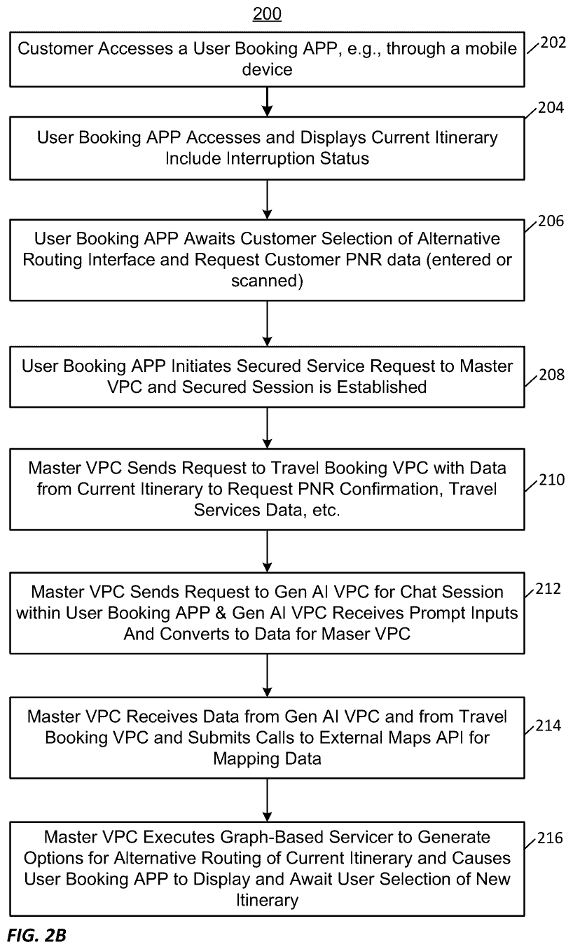

FIG. 2A illustrates various elements of the travel booking system 100 of FIG. 1. FIG. 2B illustrates a process 200 as may be executed in an example of the techniques herein. At a block 202, a customer accesses the user booking APP 104, for example on their mobile device, and the user booking APP 104 accesses and displays on that mobile device a current travel itinerary for the user, along with a status of that current itinerary. If there are any current interruptions, determined upcoming interruptions, or predicted interruptions, that information may be displayed to the user through at the user booking APP 104, at the block 204, for example through a notification banner, in application alert, or other visualization and may include an auditory alert. The user booking APP 104, at block 206, awaits a user's request to engage with an alternative routing interface for generating a listing of alternative routing options for the current travel itinerary. In response, the block 206 requests user PNR data, which may be entered by the user manually at the mobile device, scanned at the mobile device (e.g., scanning of a travel document or identification card), or otherwise obtained. The user booking APP 104 then sends a request to the VPC 108, via the block 208, to open a secured session for generating and displaying alternative routing options and for selecting an alternative travel itinerary in response. The VPC 108 establishes a secured session with the user booking APP 104 and with the travel booking VPC 112 and the Gen AI VPC 110.

At a block 210, the VPC 108 sends a request to the travel booking VPC 112 with data from the current itinerary and with a request to confirm the PNR data obtained from the user booking APP 104. Responsive to a confirmation of the PNR data, the travel booking VPC 108 may then collect flight status data for the current itinerary, as well as alternative flights data or other travel services data.

At a block 212, the VPC 108 sends a session request to the Gen AI VPC 110 for opening a chat session within the user booking APP 104. In response, the Gen AI VPC 110 may send a prompt request through the VPC 108 to the user booking APP 104 for opening a secured chat session with an interface into which the user may provide prompt input data in the form of natural language data. Prompt input data captured at the user booking APP 104 is communicated through the VPC 108 to the Gen AI VPC 110, which acts on the prompt inputs, for example, by converting the natural language data into data for consumption by the graph-based servicer 118 in the VPC 108. In some examples, the block 212 may invoke a call (sending a prompt) to an external Gen AI service, such as an external Gen AI service 213. That external Gen AI service 213 would respond to the prompts. Examples include Open AI, a LLaMA model, a PaLM model, etc. In some embodiments, a private instances of an external Gen AI service may be hosted at the Gen AI VPC 110, for example, to expedite function calls between the Gen AI VPC 110 and that private instance. These prompt responses may be visually presented to the user in the chat session on the user booking APP 104 to request specified prompt inputs. Thus, as demonstrated, the “prompt inputs” may be considered prompt input data that is processed locally and supplemented with additional context (e.g., the flight status data, alternative flights data, user preference data), as well as instructions for the appropriate output (e.g., how to process the prompt/context to identify a suitable alternative route), from which the Gen AI service 213 would return a prompt response.

In the illustrated example, at a block 214, the VPC 108 receives data from the Gen AI VPC 110 generated from the chat session and data from the travel booking VPC 112 and executes calls to an external map API 215 for mapping data. These calls may be accompanied by formatted data such as travel departure data, travel destination data, acceptable distance data, airport zip codes, nearest airport zip codes, acceptable alternative locations, acceptable modes of transportation. In some examples, the calls (also termed herein “polling”) are accompanied by data identifying locations determined at the VPC 108, the VPC 110, and/or the VPC 112. At a block 216, the VPC 108, in response to receiving mapping data from the map API 215, provides the mapping data to the graph-based servicer 118, which may be trained to generate from that data as well as from chat session data from the VPC 110 and travel services data, PNR, etc. from the VPC 112, alternative routes (for generating alternative travel itineraries) for the current travel itinerary.

From the block 216, if the user chooses one of the alternative travel itineraries, a booking request corresponding to the selected alternative travel itinerary may be generated and communicated to the travel booking VPC 112 or to other external booking system requesting rebooking of the interrupted travel itinerary to the alternative travel itinerary. In various examples, such rebooking may include communicating a request for booking with several different booking systems, such as other carrier booking systems from that of the original carrier, hotel booking systems, car rental booking systems, ride-sharing booking systems, online travel agencies, etc. A booking confirmation may be requested from each of the booking systems and, in response to receiving the booking confirmation, the alternative travel itinerary is confirmed to the traveler, for example through the interface or otherwise displayed at a user computing device.

### Example Implementation

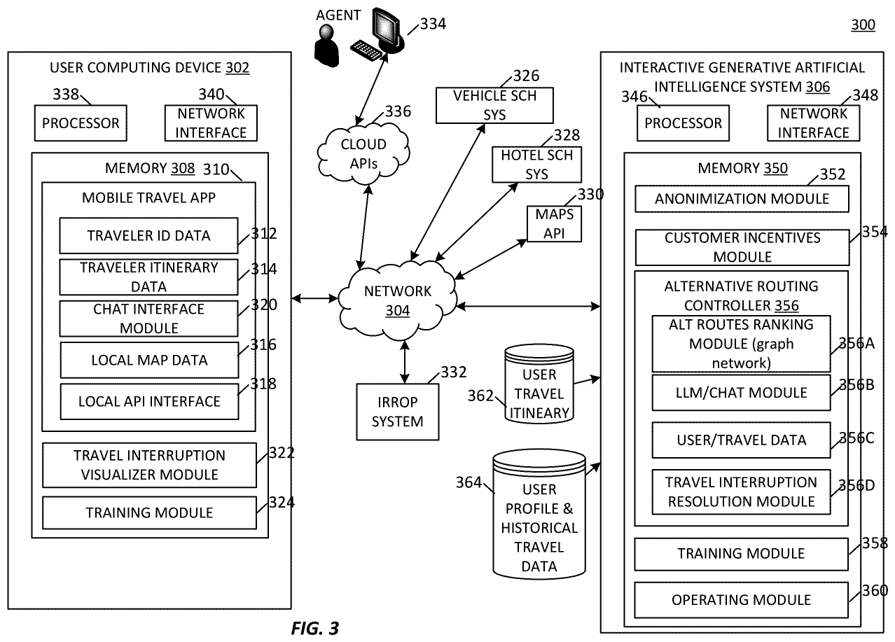

FIG. 3 illustrates another example travel booking system 300. FIG. 3 illustrates a detailed example of an example user computing device 302 communicatively coupled (through a wireless network 304) to an interactive generative artificial intelligence system 306 that may be implemented wholly or partially within a travel booking system, in accordance with an example.

In the illustrated example, the user computing device 302, such as a mobile device, includes a memory 308 executing a Mobile Travel APP 310 storing or otherwise accessing traveler identification data 312, traveler itinerary data 314, local map data 316 containing a location of the device, an API interface 318 for interfacing with APIs at the interactive generative artificial intelligence system or other APIs, and a Gen AI chat interface module 320 for displaying interfaces including prompt responses/chatbot outputs to a traveler and receiving prompt inputs from a traveler. Additionally, the memory 308 stores a travel interruption visualizer module 322 configured to display visual (e.g., graphical) information to the traveler, through a display screen of the Mobile Travel APP 310, that visual information may represent one or more alternative travel itineraries.

Optionally, in some examples, the user computing device may include trained machine learning modules 324 that may be trained and stored in a training module, as shown.

Further to facilitate processes and methods herein, the wireless network 304 may be connected to booking computer systems, such as a vehicle booking computer system 326 (e.g., a car rental computer system or ride sharing computer system) and a hotel booking computer system 328. Further, the wireless network 304 is connected to cloud accessible map data APIs 330 providing geographic data, geolocation data, location coordinate data, and other mapping data that may be used to triangulate distances between destinations, including between airport destinations, airport zip codes, vehicle locations, alternative travel modality locations, final destination meeting locations for the travelers, and the like. In some examples, the wireless network 304 is further communicatively coupled to an existing IRROP system 332. Further, dedicated personnel, such as gate agents or remote agents at an agent terminal 334 may access the wireless network 304 through travel booking system cloud APIs 336 (or other access means), as shown.

The user computing device 302 further includes a processor 338 for executing executable instructions stored in the memory 308 and a network interface 340 for establishing a secured communication link with the interactive Gen AI system 306 through the network 304.

In the illustrated example of FIG. 3, the interactive generative artificial intelligence system 306 includes a processor 346 for executing executable instructions stored in a memory 350, and a network interface 348 for establishing a secured communication link with the user computing device 302 and other computing devices, data sources, virtual private clouds, etc. connected via the network 304 or connected via other communication links.

The processors 338, 346 (and others described herein) may represent one or more processors, each of which may be a programmable microprocessor or the like that executes software or other computing instructions stored in corresponding memories to execute some, or all of the functions described herein. The processors 338, 346 may include one or more graphics processing units (GPUs) and/or one or more central processing units (CPUs), for example. Alternatively, or in addition, one or more processors may be other types of processors (e.g., application-specific integrated circuits (ASICs), field-programmable gate arrays (FPGAs), etc.), and some of the functionality of the systems as described herein may instead be implemented in hardware.

Each of the one or more memories 308, 350 (and others described herein) may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., a machine learning engine, generative artificial intelligence engine, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by one or more processors working in connection with the memories to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The networking interfaces 340, 348 may be configured to communicate (e.g., send and receive) data via one or more external/network port(s) to one or more networks or local terminals, described herein. In some embodiments, networking interfaces 340, 348 may include a client-server platform technology such as ASP.NET, Java J2EE, Ruby on Rails, Node.js, a web service or online API, responsive for receiving and responding to electronic requests. The networking interfaces 340, 348 may implement the client-server platform technology that may interact, via the computer bus, with the one or more memories 308, 350 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein. The network 304 (and other networks described herein) may present a private network or local area network (LAN). Additionally, or alternatively, the network 304 may comprise a public network such as the Internet.

In the example interactive Gen AI system 306 illustrated, the memory 350 has an optional anonymization module 352 for anonymizing traveler data (e.g., PNR data) in certain contexts, for example, when training machine learning modules of the generative artificial intelligence system. Optionally, a customer incentives module 354 is further included and may store, for example, status levels, status level rules, third party incentive rules, a rewards points module, and other financial incentive processes and data that may be desired in certain implementations.

The memory 350 further includes an Alternative Routing Controller 356 for implementing various interactive processes and methods herein, including various aspects as set forth in the claims below. It will be appreciated that the Alternative Routing Controller 356 may, in some implementations, communicate with a ‘thin’ instantiation thereof implemented on the Mobile Travel APP 310 of the user computing device.

In the illustrated example, the Alternative Routing Controller 356 includes an alternative travel itineraries ranking module 356A, e.g., that is configured to use a Graph Network or other computational optimization process to generate, assess, rank, and present alternative travel routes (and travel itineraries based on these routes) in accordance with the techniques herein. Further a trained Gen AI chatbot, for example, a large language module (LLM) 356B, provides chat operations, including providing prompt responses/chatbot outputs to a traveler and receiving prompt inputs from a traveler through the Mobile Travel APP 310. The Alternative Routing Controller 356 further includes stored user/travel 356C. Example user/travel data 356C includes traveler identification data, traveler itinerary data (e.g., from a database 362 as shown), traveler historical profile data, historical travel data, historical LLM chat data, and the like (e.g., from a database 364 as shown).

A travel interruption resolution module 356D may initiate operation of the travel booking system for generating alternative routing of a travel itinerary and coordinate calls to systems such as the vehicle booking system 326, the hotel booking system 328, the Maps API 330, etc.

For training machine learning modules of the interactive generative artificial intelligence system 306, including, for example the LLM module, a training module 358 is illustrated. An operating module 360 may control access and operation of these training machine learning modules, as well as coordinating continued training of the same using real time travel data, real time booking data, and/or traveler prompt inputs received to the LLM/Chatbot module.

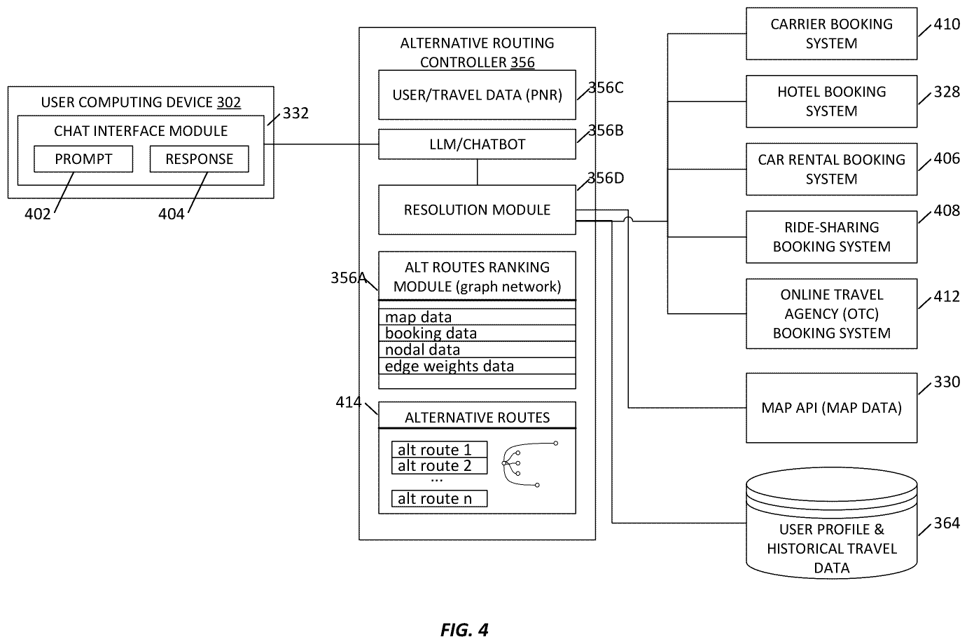

FIG. 4 illustrates an example system architecture for implementing the Alternative Routing Controller 356 through use of the LLM/Chatbot module 356B to generate and display alternative routes for interrupted travel itinerary using natural language processing. The Alternative Routing Controller 356 includes the user/travel data 356C which may include PNR data. The LLM/Chatbot module 356B provides a chat session at an interface 402 in the chat interface module 320 of the user computing device 302. User entered prompt inputs are identified as response data 404 communicated to the chatbot module 356.

The LLM/Chatbot module 356B may include instructions for pre-processing accessible data, including data collected from the data sources shown. For example, the LLM/Chatbot module 356B may perform text extraction and/or cleaning operations on data collected from data sources, including one or more vehicle booking systems such as a car rental booking system 406 or a ride-share booking system 408, the hotel booking system 328, an airline/carrier booking system 410, one or more Maps APIs 330, and an online travel agency (OTC) booking system 412. In some examples, the LLM/Chatbot module 356B receives and acts upon data from the user profile and historical travel data database 364. Depending on the configuration, the LLM/Chatbot module 356B may receive data from one or more of these data sources through the resolution module 356D which provides general control of data calls and data transfers. In some configurations, the LLM/Chatbot module 356B receives data from one or more of these data sources directly. The LLM/Chatbot module 356B may perform preprocessing operations, such as lexical parsing, tokenizing, case conversions and other string splitting/munging on received data. In some aspects, the LLM/Chatbot module 356B may perform data deduplication, filtering, annotation, compliance, version control, validation, quality control, etc. In some aspects, one or more human reviewers may be looped into the process of pre-processing data collected by the LLM/Chatbot module 356B. For example, a distributed work queue may be used to transmit batch jobs and receive human-computed responses from one or more human workers. Once pre-processed, the LLM/Chatbot module 356B may store copied and/or modified copies of the training data in an electronic database.

In some aspects the LLM/Chatbot module 356B may include instructions for parsing the unstructured text received to structure the text. For example, when the text relates to travel itineraries, the LLM/Chatbot module 356B may generate a time, travel destination, distance, travel restrictions, traveler companion, traveler status, and/or travel history data structures. The LLM/Chatbot module 356B may also label the data as desired, for example, according to historical travel patterns, previously determined weighting factors corresponding to alternative travel options, etc. Such data may be labeled according to one or more associated textual speech patterns, in a language transcript form. The data may include one or more keywords associated with the transcript. In some aspects, the present techniques may use a separate trained text summarization module to generate keywords used for this purpose. In this way, the LLM/Chatbot module 356B may generate structured data corresponding to unstructured travel data, such that the structured data is enriched with information about the traveler, travel routes, etc. that is suitable for training. This structured data may be processed by downstream processes/modules.

Generally, the present techniques, for example, implemented through the interactive generative artificial intelligence system, may train one or more models to perform language generation tasks that include token generation. Both training inputs and model outputs may be tokenized. Herein, tokenization refers to the process by which text used for training is divided into units such as words, subwords or characters. Tokenization may break a single word into multiple subwords (e.g., “LLM” may be tokenized as “L” and “LM”). The present techniques may train one or more models using a set of tokens (e.g., a vocabulary) that includes many (e.g., thousands or more) of tokens. These tokens may be embedded into a vector. This vector of token or “embeddings” may include numerical representations of the individual tokens in the vocabulary in high-dimensional vector space. The LLM/Chat module 356B may access and modify the embeddings during training to learn relationships between tokens. These relationships effectively represent semantic language meaning.

In some aspects, a specialized database (e.g., a vector store, a graph database, etc.) may be used to store and query the embeddings. Embedding databases may include specialized features, such as efficient retrieval, similarity search and scalability. For example, the interactive generative artificial intelligence system may include a local electronic embedding database (not depicted). In some aspects, a remote embedding database service may be used (e.g., via the cloud APIs). Such a remote embedding database service may be based on an open source or proprietary model (e.g., Milvus, Pinecone, Redis, Postgres, MongoDB, Facebook AI Similarity Search (FAISS), etc.). The interactive generative artificial intelligence system may include instructions (e.g., in the Alternative Routing Controller) for adding training data to one or more specialized databases, and for accessing it to train models.

The present techniques may include language modeling, wherein one or more deep learning models are trained by processing token sequences using a large language model architecture. For example, in some aspects, a transformer architecture may be used to process a sequence of tokens. Such a transformer model may include a plurality of layers including self-attention and feedforward neural networks. This architecture may enable the model to learn contextual relationships between the tokens, and to predict the next token in a sequence, based upon the preceding tokens. During training, the model is provided with the sequence of tokens, and it learns to predict a probability distribution over the next token in the sequence. This training process may include updating one or more model parameters (e.g., weights or biases) using an objective function that minimizes the difference between the predicted distribution and a true next token in the training data.

Alternatives to the transformer architecture may include recurrent neural networks, long short-term memory networks, gated recurrent networks, convolutional neural networks, recursive neural networks, and other modeling architectures.

In some aspects, the LLM/Chatbot module 356B may include instructions for performing pretraining of a language model (e.g., an LLM), for example, in a training module (including a pretraining module). The training module may include one or more sets of instructions for performing pretraining, which as used herein, generally refers to a process that may span pre-processing of training data via the LLM/Chatbot module 356B and initialization of an as-yet untrained language model. In general, a pretrained model is one that has no prior training of specific tasks. For example, the training module may include instructions that initialize one more model weights. In some aspects, training module may initialize the weights to have random values. The training module may train one or more models using unsupervised learning, wherein the one or more models process one or more tokens (e.g., preprocessed data from the LLM/Chatbot module 356B) to learn to predict one or more elements (e.g., tokens). The training module may include one or more optimizing objective functions that the training module applies to the one or more models, to cause the one or more models to predict one or more most-likely next tokens, based on the likelihood of tokens in the training data. In general, the training module causes the one or more models to learn linguistic features such as grammar and syntax. The training module may include additional steps, including training, data batching, hyperparameter tuning and/or model checkpointing.

The training module may include instructions for generating a model that is pretrained for a general purpose, such as general text processing/understanding. This model may be known as a “base model” in some aspects. The base model may be further trained by downstream training process(es), for example, those training processes described with respect to a fine-tuning module (not shown). The training module generally trains foundational models that have general understanding of language and/or knowledge. Pretraining of the training module may be a distinct stage of model training in which training data of a general and diverse nature (i.e., not specific to any particular task or subset of knowledge) is used to train the one or more models. In some aspects, a single model may be trained and copied. Copies of this model may serve as respective base models for a plurality of fine-tuned models.

Further, LLM/Chatbot module 356B (as well as the Gen AI service 132 or other generative artificial intelligence services herein) may be trained with specific data to respond to specific situations, e.g., using historical rebooking data to identify past options for tuning the LLM/Chatbot module 356B. Whether the chat session is a single instance session and not persistent or is a persistent session, the LLM/Chatbot module 356B may be tuned, for example by fine-tuning, for specific types of interruptions, for interruptions to specific regions of the country, for certain categories of travelers (e.g., different premier statuses), and/or for the specific traveler (based on their historical rebooking data). Indeed, any of the generative artificial intelligence services herein may include a set of endpoints for training and/or fine-tuning, where those endpoints facilitate generating customized datasets from data sources (e.g., the various booking systems, etc.) where those customized datasets are then used to specifically tune training so that generated prompt responses may be even further tailored to the user. In these embodiments, similarity to historical rebooking data may be used as a reward metric when applying reinforcement learning techniques during the training and/or tuning processes.

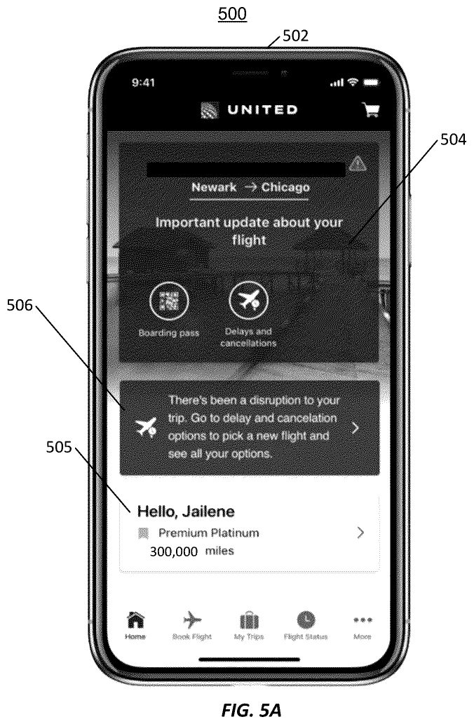

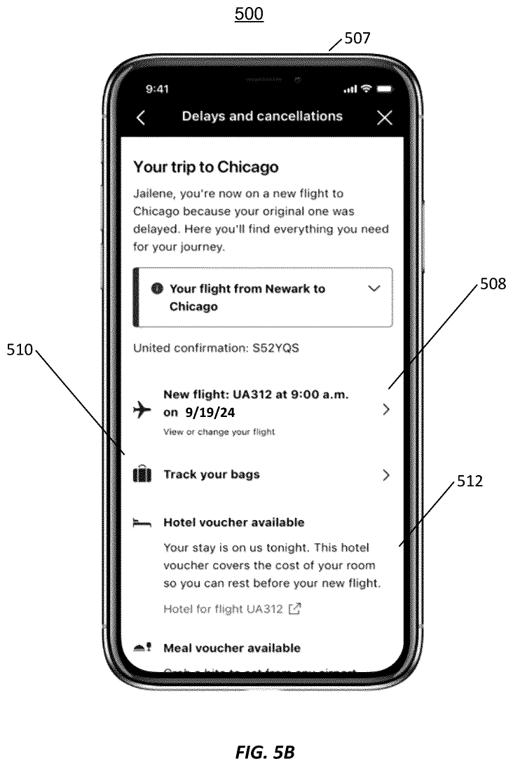

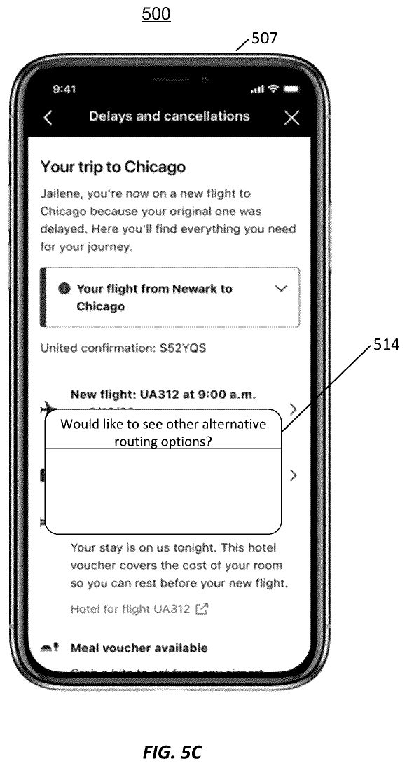

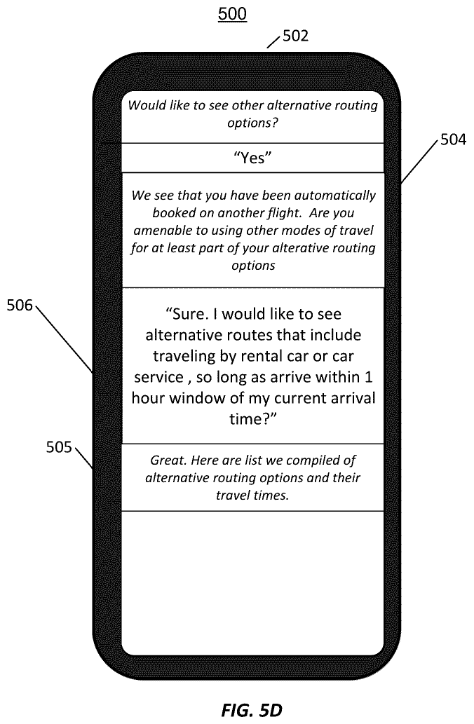

In operation, as shown in FIG. 5A, a screen 502 of a user mobile phone 500, functioning as the user computing device 302 displays current travel itinerary data 504 on a portion of the screen 502. PNR data, such as traveler identification data 505, may also be shown on a portion of the screen 502. As shown in FIG. 5A, a travel itinerary interruption alert 506 has been generated and is displayed in response to a detected interruption in travel. Such functionality may be achieved through the IRROP system 332 sending an alert, with alert reasoning, to the user computing device 302. FIG. 5B shows a screen 507 that is presented to the user in response to selecting the travel itinerary interruption alert 506 presented on screen 502. In the illustrated example, the screen 507 contains information on a newly booked (i.e., automatic rebooking) travel as automatically generated and booked by a conventional IRROP system. The traveler has been automatically booked on a new flight as displayed in a portion 508. The traveler is presented with an interface portion 510 illustrate information for tracking the bags thus providing the traveler an indication of where their checked bags are and providing them assurance that their bags will also be rerouted as a result of the automatically booked new flight listed at the portion 508. An incentive offering, phrasing, or other service, by the carrier, is provided on a portion 512 as an offering to accommodate inconvenience experienced by the traveler. In the illustrated example, that incentive offering is a shown as one or more vouchers for use with one or more third party vendors.

In the illustrated example, as shown in FIG. 5C, the screen 507 may also present (e.g., as an overlay) a chat session 514 for the user to enter natural language text (e.g., typed or dictated through a microphone and a text-to-type processing (not shown)) that may be pre-processed at the mobile phone 500 before being sent to the interactive Gen AI system 306 and in particular the Alternative Routing Controller 356 for selecting to enter into a chat to obtained alternative routing itineraries different than automatically rebook travel illustrated at the portion 508.

From the chat session 514, the user can elect to enter into an alterative routing process that generates one or more alternative itineraries for the current travel itinerary (or the illustrated automatically rebooked itinerary at portion 508). These alternative travel itineraries may include alternative routing, that is, itineraries that differ from an original in locations, numbers of locations, and/or modalities of travel. For example, entering the alterative routing process the user can select be routed through different airports or through different modalities of travel, until they ultimately reach their original destination or a sufficiently suitable other destination. The user may input at the chat interface 514 a natural language acceptance or the user may select an icon or other entry point indication on a screen presented at the user computing device 302 (e.g., the mobile phone 500). In response to selecting to enter into a chat session, the LLM/chatbot module 356B receives conversational, natural language data from the user computing device 302 and converts such response data into requests for information from the data sources shown (406, 408, 410, 412, 328, 330, and 364, or others). These may include requests for map data, booking data, and nodal data on different travel destination options that may be reviewed before an alternative routing is finalized. The nodal points, for example, may represent locations where one or more carriers routinely have airports for commercial takeoff and landing. Further data indicating edge weights between these different nodes (or not locations) can be monitored, where all such data may be stored by the alternative routes ranking module, which may apply a graph network to optimize searching. The module 356A may performing Graph Network processing on the received data to generate alternative routes, and then rank those alternative routes based on a rules criteria or based on source data provided to the LLM/Chatbot module 358B. Such ranking of alternative routes may be stored a datastore 414 in the Alternative Routing Controller 356 and presented to or otherwise made accessible to the user computing device 302, for example at the chat interface 514. The alternative routes may be stored in any suitable data format for presentation to a user at the chat interface 402 and/or for use by the resolution module 356D in sending polling requests to the different connected data sources and/or in sending requests to rebook the user and generate a new PNR. The data from the sources 406, 408, 410, 412, 328, 330, and 364, or others may include available travel data, for example, data on what travel options are available to a traveler in respond to the polling data sent to these systems, that polling data being generated from the interrupted travel itinerary and from the prompt inputs from the traveler. In some examples, the Alternative Routing Controller 356 limits the options for alternative itineraries (for example, alternating routing limitations) before generating the polling data, so that the requests to these data sources is narrowly tailored and these data sources generated a small set of response data as the available travel data. Such configurations may be desired when the Alternative Routing Controller 356 has determined from user profile and historical travel data that only a narrowed set of alternative itineraries will be acceptable to a traveler. In other examples, the Alternative Routing Controller 356 may poll for a large number of options in the available travel data from each data source, from which the Alternative Routing Controller 356 may provide the larger corpus of data to the alternative routes ranking module (or other graph network servicers herein) for assessing and weight nodes and edges in a graph network to generate and rank the alternative itineraries.

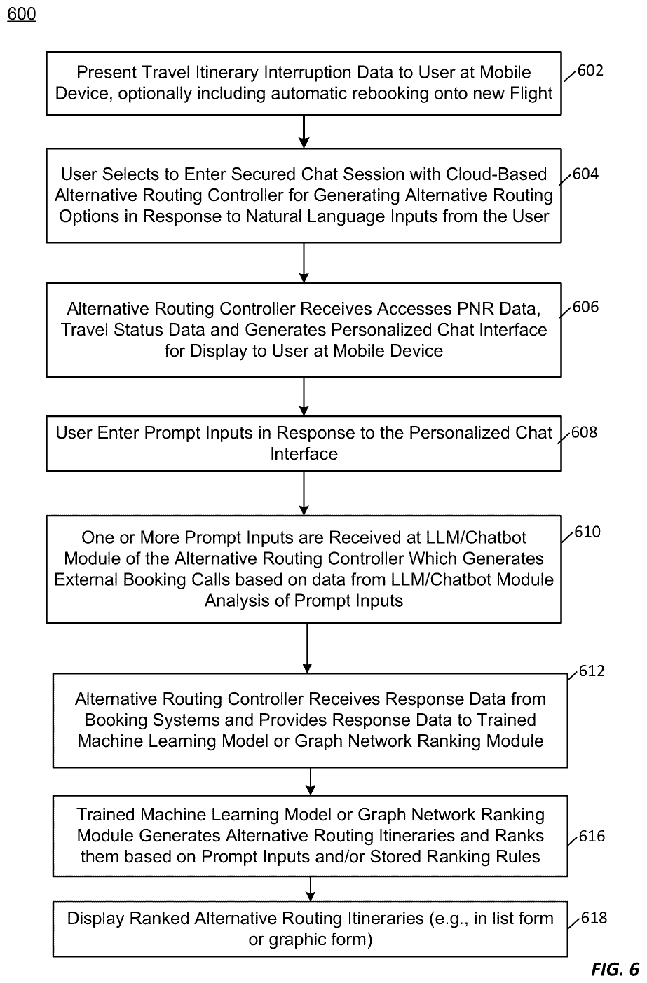

FIG. 6 illustrates an example process 600 as may be performed by a travel booking system in response to a traveler entering a chat session. At a block 602, the user is presented with travel itinerary interruption status data at their mobile device, where optionally the user may also be presented with information on a new flight they have been automatically rebooked on or have the option to select, as determined by an IRROP system or other conventional travel booking system process. At a block 604, the user enters into a secured chat session through an interface presented at their mobile device, e.g., by entering “I would like to see other routing options for my trip.” In some examples, where the user has already been automatically rebooked onto a new flight or provided with an already determined option for a new flight, the alternative routing controller with which the secured chat session is established, may communicate to the mobile device to present a natural language response to the user, such as “Please tell us what would be acceptable rerouting factors to consider for your trip? For example, would you accept a different mode of transportation for part of your trip? Are you flexible about the final arrival time to your destination?” That is, in some examples, the Alternative Routing Controller determines, at a block 606, the status of the travel interruption and whether the user has already been booked on an alternative flight. For example, in response to the request to enter a chat session, the Alternative Routing Controller may access a travel booking VPC or other repository of up-to-date PNR data, flight status data, etc. and use that data to provide a tailored interface (e.g., including a prompt response/chatbot output) to the user. In this way, the Alternative Routing Controller can generate a personalized chat interface for the customer. In some examples, the Alternative Routing Controller may access a communication rules document that includes one or more communication rules that a LLM/Chatbot module will access in generating the personalized interface. For example, the communication rules document may include parameters for the tone, gender, etc. for the personalized interface. In some examples, the personalized interface may be change depending on the nature of the interruption affecting travel. In some such examples, the Alternative Routing Controller may access supervisory data that may be manually entered at a supervisor chat interface and used to affecting the amount of personalization, the nature of the personalization, etc. of the interface presented to the user.

Responsive to the chat interface, at a block 608, the user may enter natural language prompt inputs, which the Alternative Routing Controller, at block 610, passes to the LLM/Chatbot module for assessment and for generating data that the Alternative Routing Controller uses, at block 612, for making calls (e.g., polling) to external booking systems (also termed “scheduling” systems), such as carrier booking systems, hotel booking systems, car rental booking systems, ride share booking systems, and/or OTC booking systems. The Alternative Routing Controller also makes calls to a map API in response to prompt inputs from block 608. At a block 612, response data from the external booking systems, map APIs, etc. are provided to a machine learning model trained to generate alterative routing itineraries or provided to a Graph Network Ranking Module configured to generate alternative routing itineraries and rank them based on prompt inputs from the user. In some examples, at a block 616, a trained machine learning model generates alternative routing itineraries, which are provided to a separating ranking process. In other examples, at the block 616, the Graph Network Ranking Module generates the alternative routing itineraries and ranks them. In either example, the rankings may be based on prompt inputs, specifically from the LLM/Chatbot module. The prompt inputs may be converted into one or more ranking rules data that are provided to the trained machine learning module or Graph Network Ranking Module to rank the alternative routing itineraries based on customer priorities. The ranked alternative itineraries are displayed to user at the user's mobile device, for example, in a list format or in a graphical format such as on a map displayed to the user and including the user's current location and the various alternative routes. From there, the user may select a desired alternative travel itinerary (e.g., one having a different routing than the original) through the interacting with that display or through providing natural language selection as an input to the chat session. FIG. 5D illustrates an example of various personalized chat interfaces (with prompt response/chatbot outputs) and prompt inputs resulting in a list of ranked alternative routing options.

The techniques herein allow a traveler to insert any number of prompt inputs that may be used to generate and rank alternative itineraries. For example, a travel interruption may impact multiple travelers who are traveling together, for example, as may be indicated in PNR data. Prompt responses/chatbot outputs from the Gen AI VPC, LLM/Chatbot, or other generative artificial intelligence systems herein, may include information on the interruption impacting these secondary travelers. Prompt inputs from the primary traveler may be provided to the interactive generative artificial intelligence system which may then obtain travel data for these secondary travelers and use that data in generating alternative travel itineraries for the primary traveler. For example, nodes, edges, node weights, and edge weights may be determined based on the additional travel data for the secondary traveler(s). In some examples, the interactive generative artificial intelligence system stores prompt inputs from each of the travelers associated with a PNR and then uses that data to generate tailored alternative itineraries for each traveler. In this way, for example, a series of travelers traveling together, for example, that booked an original travel through a single traveler's account, may be presented with alternative travel itineraries that differ from those provided to other travelers in that group. The itineraries may differ from each other in departure location, arrival destination, different travel modalities, total travel time, for example. Thus, from a single original travel itinerary for multiple travers, multiple different groupings of alternative travel itineraries may be generated. Further, each travel may be presented with a different ranking of those alternative travel itineraries.

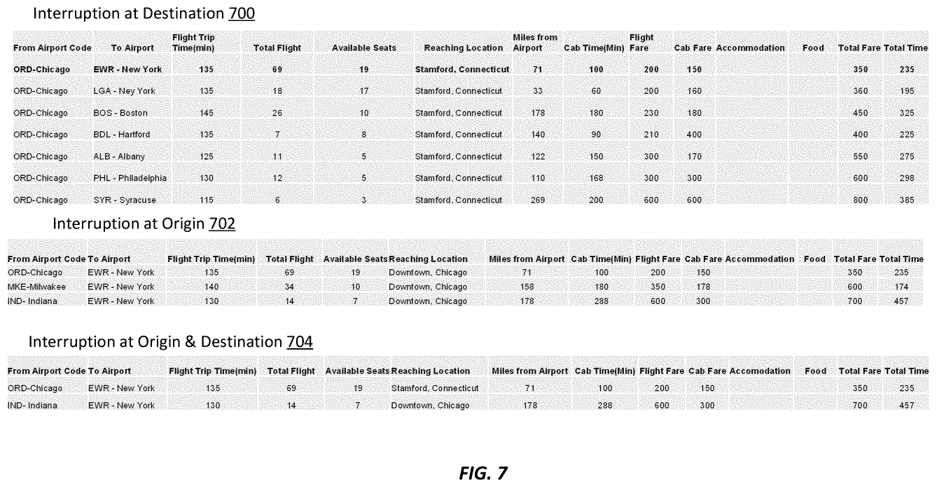

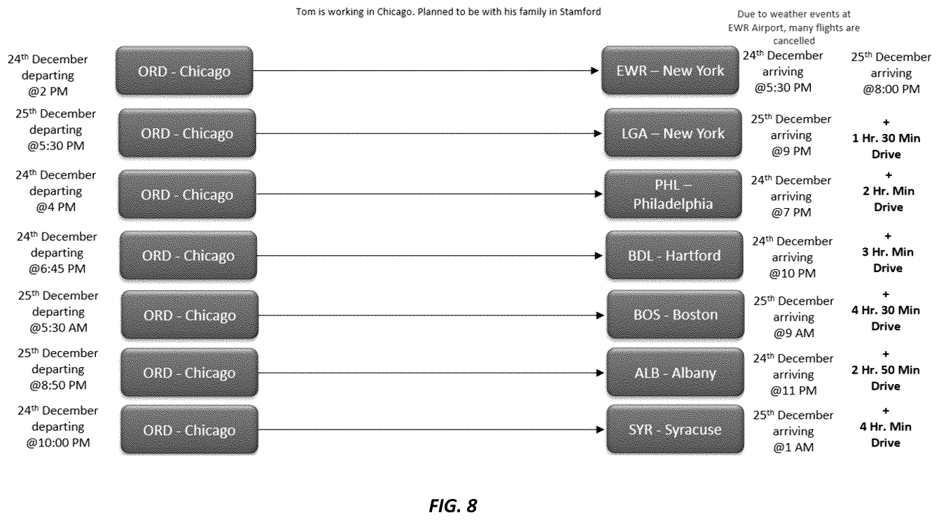

FIG. 7 illustrates alternative routing itineraries compiled and ranked based on three different types of travel interruptions. Ranking 700 provides options for alternative routing based on an interruption to flight status affecting a destination airport. Ranking 702 provides options for alternative routing based on an interruption to flight status affecting a departure airport. Ranking 704 provides options for alternative routing based on an interruption to flight status affecting a both a destination airport and a departure airport. As shown the Alternative Routing Controller has ranked alternative routings using data such as a destination airport, arrival airport, total flight time, available seats, distances to final destination, miles from original destination airport, miles from original departure airport, time for car fair, projected cost of car fair, data on accommodations if needed, data on food if needed. FIG. 8 illustrates an example display of ranked alternative routing itineraries that may be presented to the user at a mobile device, allowing the user to select a desired routing which the Alternative Routing Controller may confirm and provide to a travel booking system to complete rebooking to that desired routing. Of course, of the alternative travel itineraries generated in responsive to the prompt inputs from the traveler, the techniques herein may display a portion of ranked alternative travel itineraries at a time, and through the chat interfaces provided by the interactive Gen AI functions herein.

As shown in the examples of FIGS. 7 and 8, the present techniques may use generative artificial intelligence to generate a number of different alternative itineraries, where at least some of these may include an alternative itinerary having a different routing than the original itinerary, for example, having a destination different than the original travel destination and/or having a travel modality than the original travel modality (such as including use of a rental car or car service in addition to a flight).

### Additional Considerations

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112 (f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one aspect” or “an aspect” means that a particular element, feature, structure, or characteristic described in connection with the aspect is included in at least one aspect. The appearances of the phrase “in one aspect” in various places in the specification are not necessarily all referring to the same aspect.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the aspects herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular aspects and applications have been illustrated and described, it is to be understood that the disclosed aspects are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for generating alternative routing of a travel itinerary using an interactive generative artificial intelligence system, the computer-implemented method comprising:
in response to receiving an electronic indication of an interruption of a travel itinerary of a traveler, obtaining travel identification data for the traveler and itinerary data corresponding to the traveler;
configuring an interactive generative artificial intelligence system for providing respective interaction interface electronically to the traveler, the interactive generative artificial intelligence system comprising a plurality of trained system objects, each system object including a respective trained machine learning module;
in response to an access request from the traveler, causing the interactive generative artificial intelligence system to provide interaction prompt responses to the traveler regarding the interruption of the travel itinerary and to receive prompt inputs from the traveler responsive to the interaction interface;
in response to the prompt inputs from the traveler, accessing routing data corresponding to one or more alternative travel itineraries; and
causing, through the interaction interface provided by the interactive generative artificial intelligence system, information on the one or more alternative travel itineraries to be displayed to the traveler as prompt responses, including generating and displaying a visual indication of the information on the one or more alternative travel itineraries.

2. The computer-implemented method of claim 1, wherein accessing the routing data corresponding to one or more alternative travel itineraries comprises:
generating, from data of the itinerary data and from the prompt inputs from the traveler provided to the interactive generative artificial intelligence system, polling data; and
accessing, with the polling data, a booking computing system selected from the group consisting of a carrier computing system, a hotel computing system, a car rental computing system, a ride sharing computing system, and an online travel agency computing system.

3. The computer-implemented method of claim 2, further comprising: responsive to the polling data, generating, at the booking computing system, the information on the one or more alternative travel itineraries.

4. The computer-implemented method of claim 2, further comprising:
responsive to the polling data, generating, at the booking computing system, available travel data;
receiving the available travel data from the booking computing system; and
responsive to the available travel data, generating the information on the one or more alternative travel itineraries.

5. The computer-implemented method of claim 1, further comprising:
generating, from data of the itinerary data and from the prompt inputs from the traveler provided to the interactive generative artificial intelligence system, polling data; and
communicating the polling data to an online travel agency computing system to cause the online travel agency computing system (i) to generate the information on the one or more alternative travel itineraries and (ii) to communicate the information on the one or more alternative travel itineraries to the interactive generative artificial intelligence system.

6. The computer-implemented method of claim 1, wherein the itinerary data comprises an original travel destination and an original travel modality, wherein the one or more alternative travel itineraries include at least one alternative travel itinerary having a travel destination different than the original travel destination.

7. The computer-implemented method of claim 1, wherein the itinerary data comprises an original travel destination and an original travel modality, wherein the one or more alternative travel itineraries include at least one alternative travel itinerary having a travel modality different than the original travel modality.

8. The computer-implemented method of claim 1, wherein there are plurality of the alternative travel itineraries, the method further comprising:
responsive to the prompt inputs from the traveler, ranking the plurality of alternative travel itineraries; and
displaying at least a portion of the ranking of the plurality of alternative travel itineraries through the interaction interface provided by the interactive generative artificial intelligence system, wherein the visual indication corresponds to the ranking of the plurality of alternative travel itineraries.

9. The computer-implemented method of claim 1, wherein there are a plurality of the alternative travel itineraries, the computer-implemented method further comprising:
obtaining map data, alternative route data, and booking data and providing the map data, the alternative route data, and the booking data to a trained graph-network machine learning model trained to generate a graph network of available route alternatives, the graph network comprising a plurality of nodes, each node representing a different alternative travel destination different than an original travel destination of the travel itinerary.

10. The computer-implemented method of claim 9, further comprising: assessing, in a trained machine learning model, the graph network against the prompt inputs from the traveler and applying weights to each of the plurality of nodes based on the prompt inputs from the traveler.

11. The computer-implemented method of claim 10, further comprising: applying updated weights to each of the plurality of nodes in response to subsequent prompt inputs from the traveler to the interactive generative artificial intelligence system.

12. The computer-implemented method of claim 9, further comprising: applying weights to each of the plurality of nodes based on historical data corresponding to the traveler.

13. The computer-implemented method of claim 12, wherein the historical data comprises previously provided prompt inputs from the traveler to the interactive generative artificial intelligence system from a previous alternative routing session.

14. The computer-implemented method of claim 9, further comprising updating the graph network with real-time travel availability data from a carrier and/or real-time booking data from a booking computer system.

15. The computer-implemented method of claim 1, wherein the visual indication of the information on the one or more alternative travel itineraries comprises map data corresponding to an original travel destination for the itinerary data and map data corresponding to an alternative travel destination different than the original travel destination.

16. The computer-implemented method of claim 1, further comprising:
in response to prompt input from the traveler having received the information on the one or more alternative travel itineraries, generating an alternative travel itinerary corresponding to a selected alternative travel itinerary.

17. The computer-implemented method of claim 16, further comprising:
generating a booking request corresponding to the selected alternative travel itinerary;
communicating the booking request to an external booking system requesting a booking and a booking confirmation; and
in response to receiving the booking confirmation, confirming the alternative travel itinerary to the traveler.

18. The computer-implemented method of claim 1, further comprising:
identifying a plurality of interruptions of travel itineraries each corresponding to different secondary travelers, obtain travel identification data for the secondary travelers and itinerary data corresponding to the secondary travelers; and
determining the one or more alternative travel itineraries based on (i) the plurality of interruptions of travel itineraries, (ii) the travel identification data for the secondary travelers, and/or (iii) the itinerary data corresponding to the secondary travelers.

19. The computer-implemented method of claim 1, wherein the information on the one or more alternative travel itineraries includes information obtained from an airline reservation database.

20. The computer-implemented method of claim 19, wherein the information obtained from the airline reservation database comprises flight information for flight segments of the one or more alternative travel itineraries.

21. A computing system for generating alternative routing of a travel itinerary using an interactive generative artificial intelligence system, the computing system comprising:
one or more processors, and
one or more memories having stored thereon computer-executable instructions that, when executed by the one or more processors, cause the computing system to:
in response to receiving an electronic indication of an interruption of a travel itinerary of a traveler, obtain travel identification data for the traveler and itinerary data corresponding to the traveler;
configure an interactive generative artificial intelligence system for providing respective interaction interface electronically to the traveler, the interactive generative artificial intelligence system comprises a plurality of trained system objects, each system object including a respective trained machine learning module;
response to an access request from the traveler, cause the interactive generative artificial intelligence system to provide prompt responses to the traveler regarding the interruption of the travel itinerary and to receive prompt inputs from the traveler responsive to the interaction interface;
in response to the prompt inputs from the traveler, access routing data corresponding to one or more alternative travel itineraries; and
cause, through the interaction interface provided by the interactive generative artificial intelligence system, information on the one or more alternative travel itineraries to be displayed to the traveler, including to generate and to display a visual indication of the information on the one or more alternative travel itineraries.
